(19) United States
(12) Patent Application Publication
(10) Pub. No.: US 2021/0131732 A1
(43) Pub. Date: May 6, 2021

(54) APPARATUS AND METHOD FOR DRYING FOR WET MATRICES

(71) Applicant: Solwa S.R.L., Trissino (Vicenza) (IT)

(72) Inventor: Paolo FRANCESCHETTI, Trissino (Vicenza) (IT)

(21) Appl. No.: 17/256,480

(22) PCT Filed: Jun. 28, 2019
(86) PCT No.: PCT/IB2019/055504

§ 371 Date: Dec. 28, 2020

(30) Foreign Application Priority Data
Jun. 29, 2018 (IT) 102018000006823
Jun. 29, 2018 (IT) 102018000006824

(51) Int. Cl. F26B 21/08; F26B 21/04

(52) U.S. Cl. CPC F26B 21/086; F26B 23/005; F26B 21/04

(57) ABSTRACT

A drying apparatus of a wet matrix includes air insufflation/suction means, suitable for generating a drying flow directed towards the wet matrix in at least one drying chamber, to facilitate removal of water from said wet matrix, and means for conveying the wet matrix inside the drying apparatus, having a conveyor belt that carries the wet matrix along a longitudinal direction (X-X). Advantageously, the drying apparatus has at least one heat exchanger cooled below dew temperature to condense humidity of air coming from the wet matrix.

### FIELD OF APPLICATION

The present invention relates to an apparatus for treating and drying wet matrices and a relative method of treating and drying wet matrices.

### PRIOR ART

First of all, the present invention finds particular, though not exclusive, application in the technical field of the treatment and drying of wet materials or matrices, such as food in general and/or in the field of sludge of various origins, to reduce the water content thereof and/or other volatile compounds, as well as moist or wet of a different nature.

As is known, there are various systems both at an industrial and artisan level for drying wet matrices. At world level there are systems aimed at optimizing the processes that can remove the water present inside the matrix that one wants to dehydrate. Various technologies have been developed over the years including the use of microwave systems (MAD), radio frequency (RFD) or infrared dryers (IRD). The most cost-effective, robust and globally widespread method are drying chambers in which the temperature rises, waiting for the water content to evaporate from the solid matrix. In recent decades, the ventilation function of the drying chamber with hot air injection (AD) has been added to simple overheating. In fact, it has been shown that the effect of ventilation helps significantly in the reduction of drying times and the efficiency thereof. Ventilation mainly affects the creation of a dry environment inside the dryer, removing the humidity deriving from the evaporation of the wet matrix and thus creating a dry environment that stimulates evaporation itself.

Known hot-air dryers conventionally have two energy supply sources, one thermal and one electric, the latter used for the movement of air inside the drying chamber. The higher cost of managing a drying apparatus derives from the significant consumption of energy (fuels or electricity) necessary to raise the temperature of the air introduced into the system. At present the operating cost varies from 20 to 60 €/ton of water extracted from the wet substrate, a value which varies according to the type of substrate treated and the optimization of the dryer used, as well as to the fuel used for the generation of heat. To overcome these management costs, methods are being researched that allow for the finding of alternative economic sources of energy, such as solar radiation or renewable sources, as well as the efficiency of managing superheated air flows.

With regard to air flows, they must perform a variety of functions in order to achieve the maximum efficiency in extracting water from the wet matrix during drying. These requirements can be listed as follows:
Uniform distribution of ventilation inside the drying chamber, in order to guarantee uniform treatment of the entire product subject to the drying process;
Fast and effective removal of vapor from the material being dried, in order to aid rapid drying;
Lower possible volume of ventilation and with lower thrust pressure, in order to reduce both the electrical consumption of the moving parts (fans) and the energy consumption for heating the air mass.

Then there are specific technical problems related to the type of wet matrices to be treated.

Wet matrices, in particular those of biological origin, have a density and a physical behavior that varies according to their moisture content. Generally the wet matrices in the shovelable state have a water content of from 86% to 70% of the weight. These matrices tend to form agglomerates, deriving from the physical and chemical features that constitute them, generating a difficulty in their management and processing by mechanical means. To this end, a wet matrix loading system inside a drying oven is necessary in order to reach the goal of maintaining a constant granulometry, a distribution over the entire width of the work table and preventing the possible formation of “bridges” inside the hopper and inlet of the oven.

Another problem that is found is the decrease in the volume of the wet matrix during the drying steps. As the water is removed from the wet matrix, it undergoes a granulation agglomeration process and a substantial volume reduction (up to 60% of the initial volume). This reduction in volume leads to the formation of empty spaces inside the conveyor belts inside a dryer, causing a loss of efficiency in the drying process (loss of “useful air”). This loss is more evident if the process takes place inside a closed-circuit air drier, where the air mass is cooled and overheated through heat exchangers respectively cooled or heated by fluids or vapors at different temperatures, through but not exclusively a heat pump. This loss of “useful air” causes a thermal drift of the system itself and in particular of a heat pump, causing an over temperature and a reduction in efficiency.

In order to improve the energy efficiency of the treatment and drying apparatuses of wet matrices, heat pump systems have been introduced.

These heat pump systems significantly reduce energy consumption but are extremely sensitive to the type/granulometry of the wet matrix to be treated: in other words, the efficiency that can be obtained by using heat exchangers in which the main drying force for the drying does not lie in the temperature of the air introduced but in its difference in vapor pressure between the sludge and the relative humidity of the air. In fact, in these systems the efficiency is strongly linked to the degree of crushing or granulometry of the wet matrix which must be finely controlled in order to exploit all the energy saving advantages connected with the use of said heat pumps. The current heat pump systems of the prior art do not allow an adequate exploitation of the advantages obtainable through the use of heat pumps in which the main drying force does not reside in the temperature of the air introduced but in its vapor pressure difference between the sludge and the relative humidity of the air.

### DISCLOSURE OF THE INVENTION

In light of the foregoing, it is clear that the solutions of the prior art do not allow the implementation of a drying apparatus which is efficient in extracting water from the wet matrix during drying, while ensuring low energy consumption.

The need is therefore felt to provide an apparatus or device capable of effectively and at low cost drying the wet materials inside a drying chamber. These requirements are met by a drying apparatus for wet matrices according to claim 1 and by a method of drying wet matrices according to claim 17.

### DESCRIPTION OF THE DRAWINGS

Further features and advantages of the present invention will appear more clearly from the following description of preferred non-limiting embodiments thereof, in which:

FIG. 1 is a perspective view of a system for loading wet matrices or sludge for a drying apparatus according to an embodiment of the present invention;

FIG. 2 shows a lateral view of the sludge loading system of FIG. 1 from the side of arrow II in FIG. 1;

FIG. 3 shows a plan view of the sludge loading apparatus of a drying apparatus of FIG. 1, from the side of arrow III in FIG. 1;

FIG. 4 shows a lateral partially sectional view of the apparatus for loading the wet matrices (sludge) of a drying apparatus of FIG. 1, from the side of arrow IV in FIG. 1;

FIG. 5 shows a lateral view of the apparatus for loading the wet matrices (sludge) of a drying apparatus of FIG. 1, from the side of arrow V in FIG. 1;

FIGS. 6-7 show lateral views, from different angles, of an input roller of the apparatus for loading the wet matrices (sludge) of a drying apparatus of FIG. 1 according to an embodiment of the present invention;

FIGS. 8-10 show a perspective view and two lateral views, respectively, of an intermediate crushing system for the drying apparatus of the present invention, according to a possible embodiment of the present invention;

FIGS. 11-12 show perspective views of internal parts of the drying apparatus according to embodiments of the present invention.

Elements, or parts of elements, in common to the embodiments described below are referred to by the same reference numerals;

FIG. 13 shows a perspective view of a system for loading wet matrices or sludge for a drying apparatus according to a further embodiment of the present invention;

FIG. 14 shows an enlarged perspective view of detail XIV shown in FIG. 13;

FIGS. 15-16 show views from different angles of the detail in FIG. 14;

FIG. 17 shows a perspective view of the enlarged detail XVII shown in FIG. 14;

FIG. 18 shows a schematic view of the operation of the apparatus to the present invention.

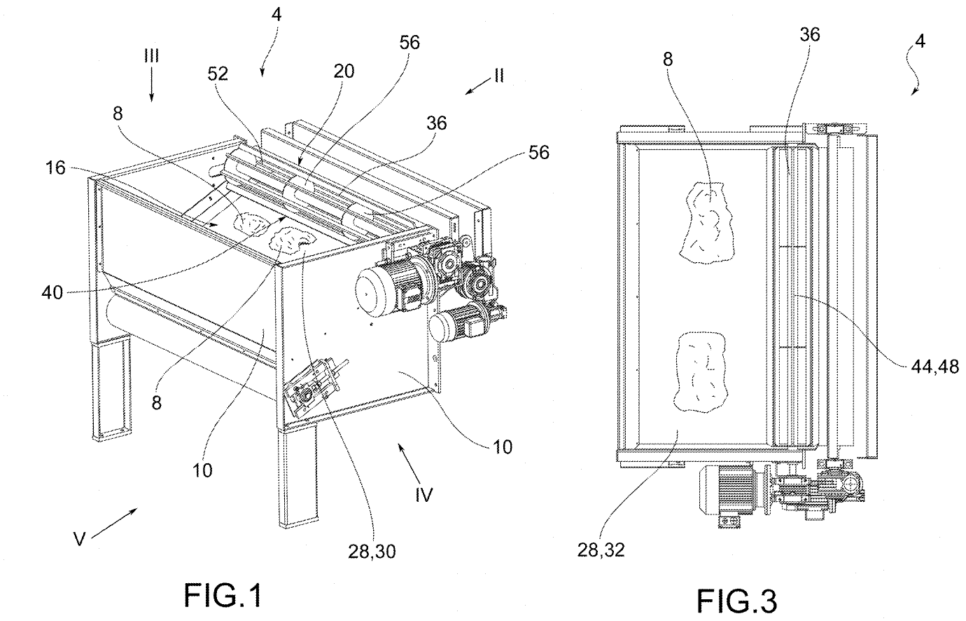

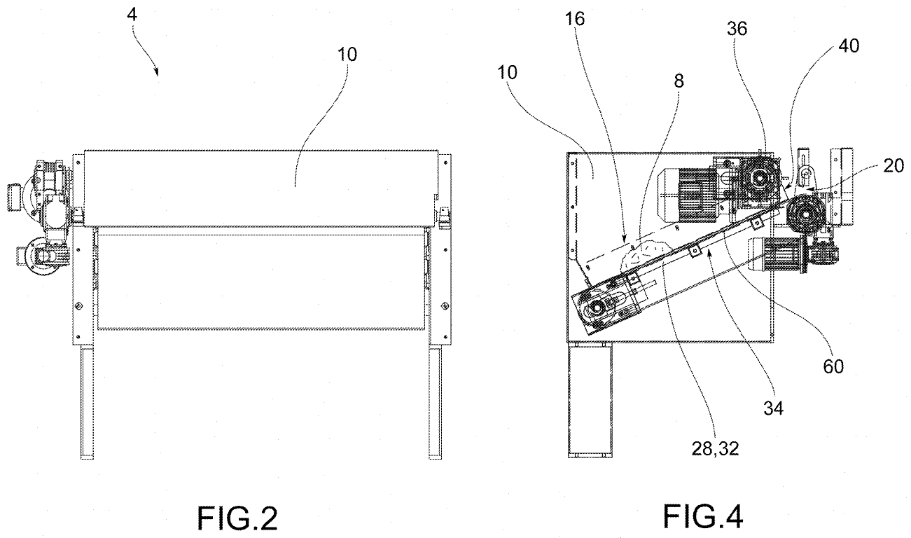

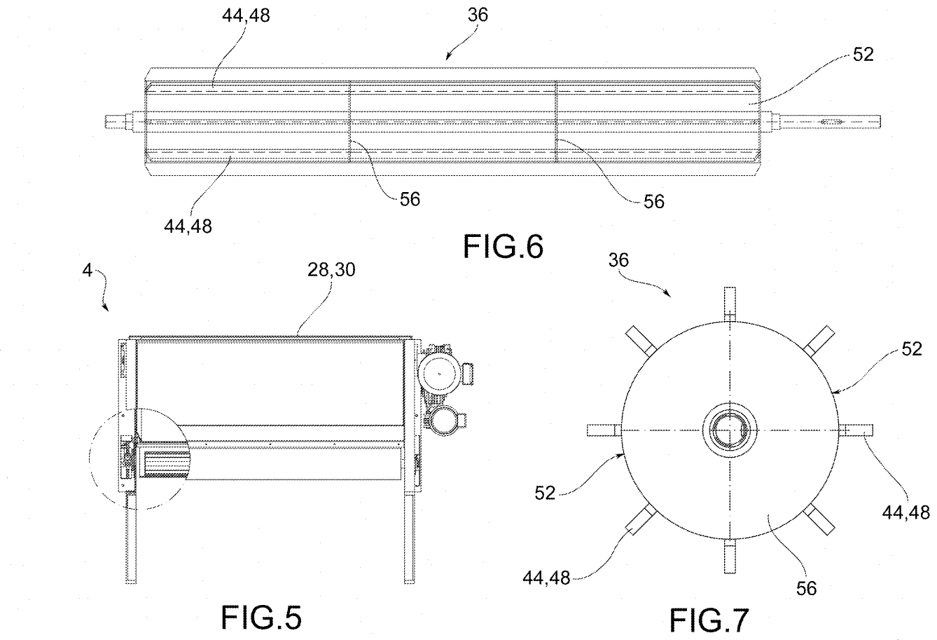

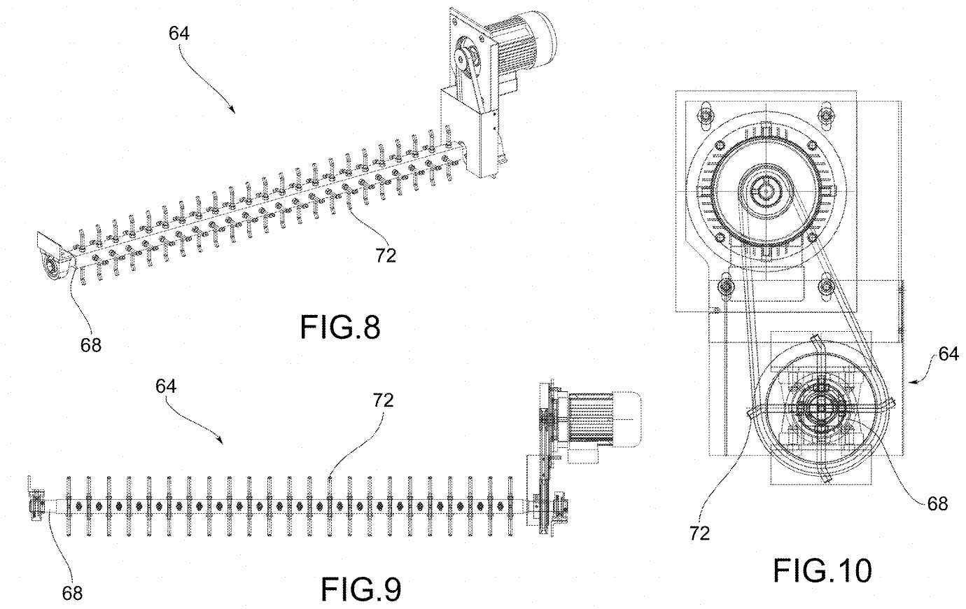

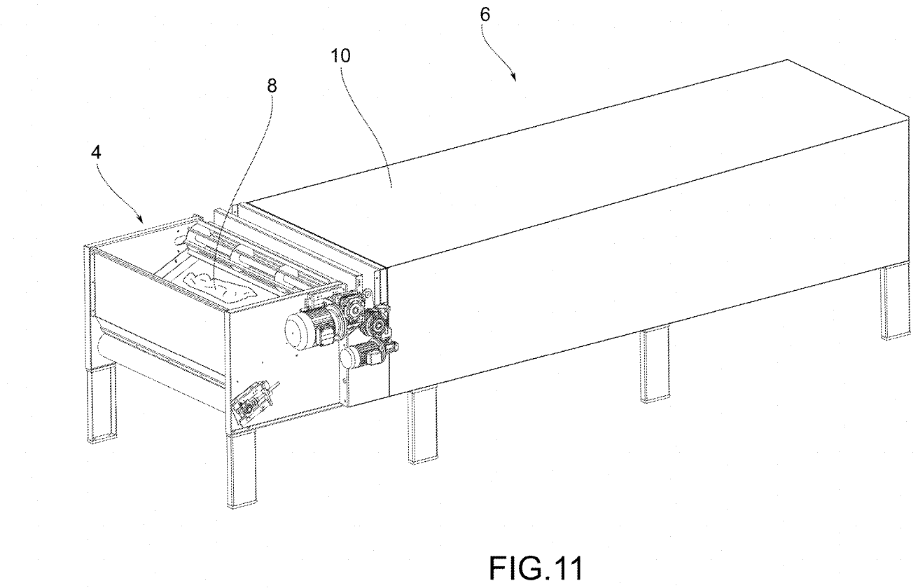

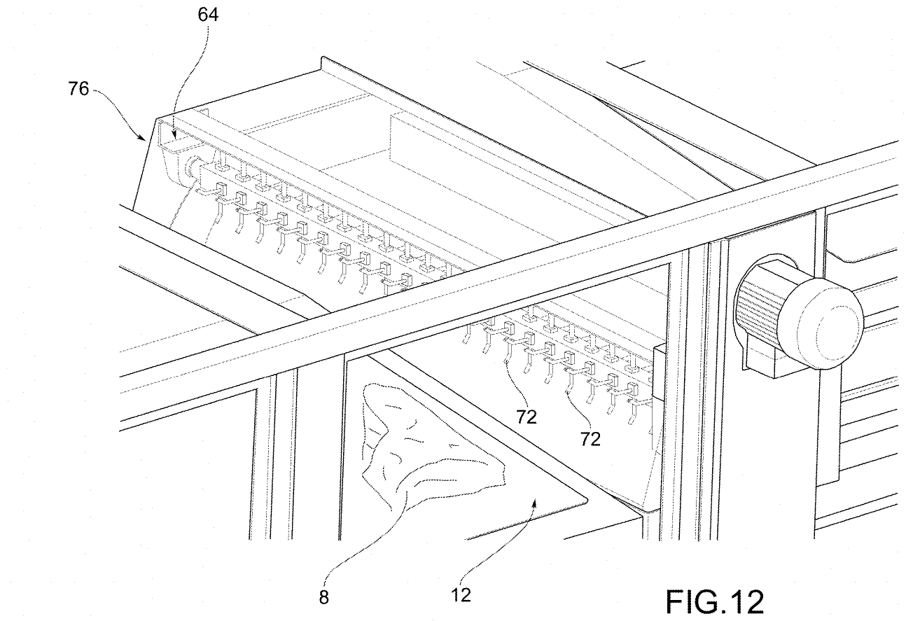

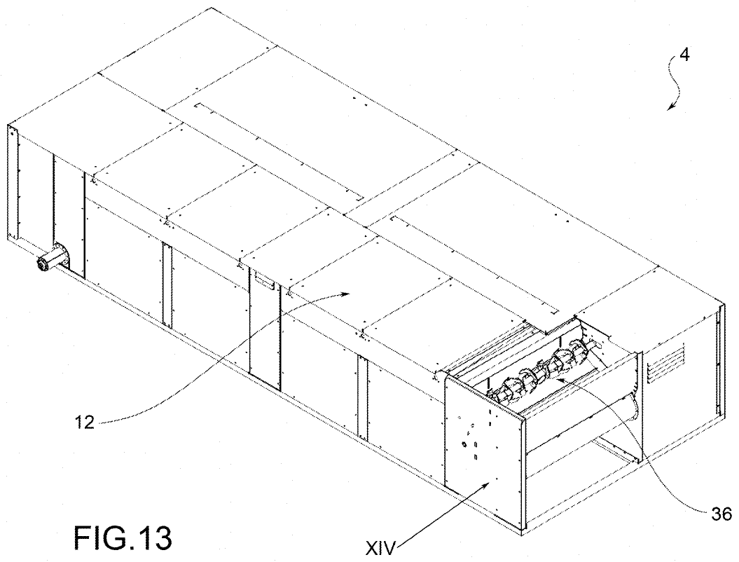

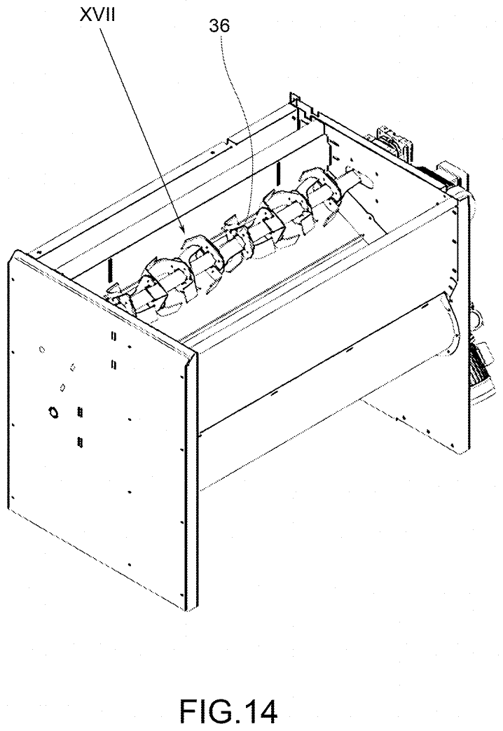

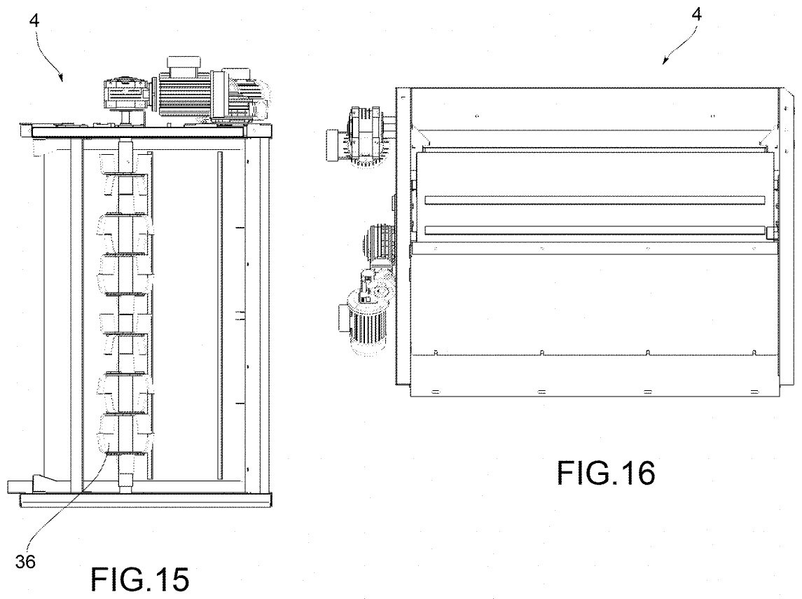

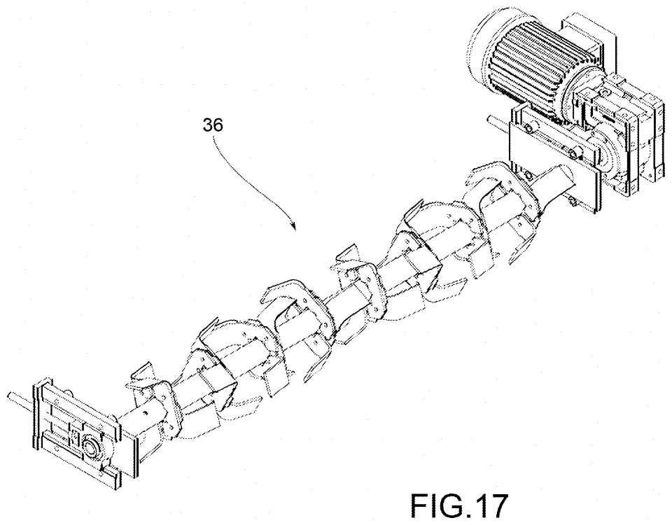

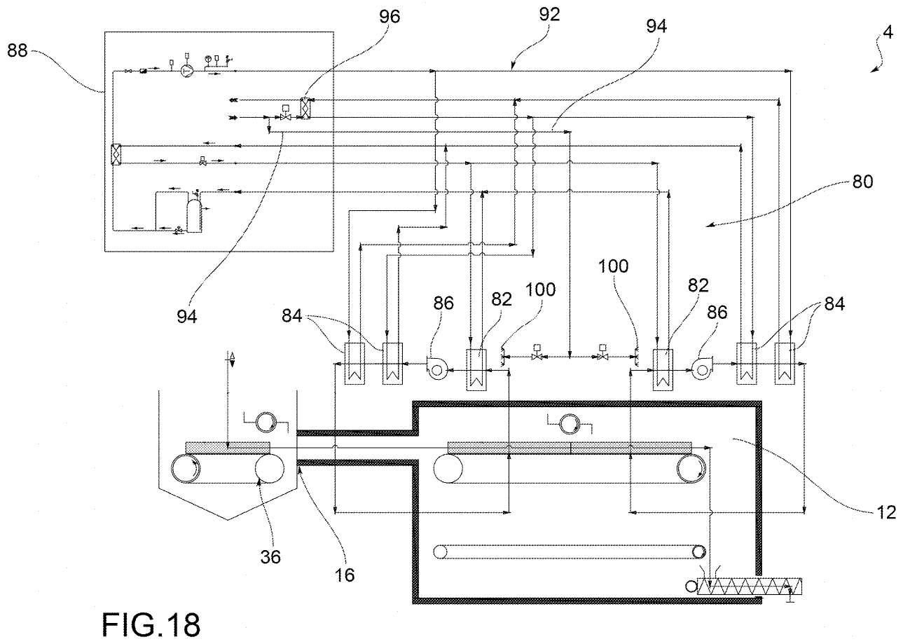

### DETAILED DESCRIPTION

With reference to the above figures, reference numeral 4 globally indicates an apparatus for loading the wet matrices (sludge) of a drying apparatus 6 for a wet matrix 8 according to the present invention.

It should be noted that, for the purposes of the protection of the present invention, the specific type of wet matrix to be treated is not relevant. For example, the apparatus finds its main application on loose wet matrices, but it may also be applied to joined wet materials, such as surfaces or fabrics, for which drying of the material is necessary.

The wet matrix may also be food-grade.

The drying apparatus 6 of the wet matrices (sludge) 8 comprises a container body 10 which delimits a drying chamber 12, suitable for housing at least one wet matrix to be dried according to a predetermined degree of drying. By a determined degree of drying it is meant that the wet matrix may have a residual humidity at the end of the drying process, depending on the needs of the user. This degree of drying may be determined by the user by acting on suitable parameters of the apparatus, as better described below.

The drying chamber 12 has a suitable insulating thermal insulation in order not to disperse the fluid thermal flow, preferably hot air, blown therein, and has hermetic closures.

The container body 10, or loading hopper, extends from an input opening 16, for the introduction of the wet matrix 8 to be dried, to an outlet opening 20, for defining the layer of material entering the drying chamber of a drying apparatus of wet matrices. This outlet opening 20, composed of a bulkhead, is able to isolate, in synergy with the wet material 8, the interior of the drying chamber from the external environment.

The drying apparatus 6 comprises air insufflation/suction means 24 adapted to generate and send a drying fluid flow, such as air, on the wet matrix inside said drying chamber 12, to remove moisture and/or water from said wet matrix 8. The use of air as a drying medium is certainly preferred; in any case it is possible to use other drying means, in the gaseous state.

The insufflation/suction means 24 may comprise forced ventilation means, such as for example fans (not shown), and natural ventilation, such as for example chimneys (not shown), to create the required flow rate of fluid.

The present invention is particularly advantageous and synergically linked to the intrinsic features of a belt drying apparatus 6 with low-temperature air recirculation, in which the main drying force is given by the difference in vapor pressure of the humidity of the air.

In particular, from the fluid dynamic and thermodynamic point of view, as mentioned above, the drying apparatus 6 comprises air insufflation/suction means 24 adapted to generate and send a drying fluid flow, such as air, on the wet matrix 8 inside said drying chamber 12, to remove moisture and/or water from said wet matrix 8.

According to a possible embodiment, the drying apparatus 6 comprises at least one heat exchanger 80 cooled below the dew temperature in order to condense the humidity of the air that comes from the wet matrix 8.

Preferably, the drying flow is recirculated through two heat exchangers, namely a cooled exchanger or evaporator element 82 and a superheated exchanger or condenser element 84 in order to first dehumidify and then superheat/dry the recirculated air.

Said heat exchangers 82, 84 may be integrated in a single heat pump 88. The heat pump 88 finds its necessary application in the present invention, allowing to condense the humidity of the air deriving from the wet matrix 8 being dried, through the cooled exchanger 82, and subsequently to heat the same air with the superheated exchanger 84.

Said heat exchangers 82, 84 are connected in series with each other by at least one fan 86 which creates a flow of air that can flow in series with each other said heat exchangers 82, 84, as better described below.

The possibility of condensing the humidity and at the same time the possible pollutants allows the dryer 6 to recirculate the same air, avoiding emissions outside the dryer 6 itself. The dryer 6 with closed air circuit through the heat pump 88, in order to improve its performance, finds CO2 as the preferable but not exclusive refrigerant gas, ensuring higher air superheating temperatures than other refrigerant gases.

The present innovation in the production of a dryer 6 for wet matrices 8 with closed air circulation involves a problem called “thermal drift” which leads to an increase in the internal temperature of the dryer 6 as the processing time passes.

For this purpose a suitable circuit of the coolant liquid and of the construction of the superheated exchanger 84 are necessary. In the present description, the superheated heat exchanger 84 has a double circuit in series, comprising a coolant delivery circuit 92 and a coolant return circuit 94.

Between said coolant delivery and return circuits 92, 94 a further heat exchanger is preferably interposed, i.e. a cooling heat exchanger 96 adapted to lower the excess heat deriving from the dryer 6.

Such a cooling heat exchanger 96 has two flows, one of coolant liquid and one of cold liquids or air.

The combination of the superheated heat exchanger 84 and the cooling heat exchanger 96 allows the dryer 6 to be kept in constant thermal balance and to obtain the best performance in order to dry the wet matrix 8 present therein. In other words, the presence of a closed circuit of the air inside the dryer 6 necessarily requires a controlled thermal dispersion (cooling heat exchanger 96 interposed).

The process of extracting the water contained in the wet matrix 8 is guaranteed by the use of a heat pump 88 (one or more) which according to an embodiment may provide for the use of CO2 coolant.

In particular, the air flow that passes through/touches the wet matrix 8 is collected and sent to the cooled exchanger 82 which dehumidifies and cools the air, which is suctioned by the fan element 86 which pushes the air through the superheated exchanger 84 which increases the temperature reducing the relative humidity level. According to a possible embodiment, the flow of air conveyed into the drying chamber 12 is split into two separate circuits, while the coolant circuit is unique and is split in parallel on two cooled exchangers 82 and on two superheated exchangers 84 (one for each air circuit) to allow greater control of the exchange efficiency between the air and the wet matrix 8 crossed/lapped in two distinct areas: the first air circuit processes a flow which involves the first part of the wet matrix 8, whose arrangement on the conveyor belt is given by the hopper loading system 10 and containing a high quantity of water, while the second air circuit processes a flow which involves the second part of the wet matrix 8, whose arrangement on the conveyor belt 32 is the result of the overturning of the material due to the intermediate movement element 64 and having a water content on the average lower than the first part of the wet matrix 8. The air circuits are made so as to ensure the airtightness thereof and the continuous recycling of the only air inside them and inside the drying chamber.

The cooled 82 and superheated 84 exchangers, and the cooling heat exchanger 96 are, on the coolant side, placed in communication preferably but not exclusively through a thermostatic expansion valve, a liquid receiver, a heat recovery unit and a compressor.

The coolant circuit of the superheated exchanger 84 may, for example, be interrupted, to ensure the necessary disposal of the heat accumulated by the system, minimizing the penalizing effects on the overall efficiency of the thermodynamic process.

According to a possible embodiment, the cooled exchangers 82 are provided with a cleaning system 100 able to eliminate the @@@solid residue of wet matrix entrained by the air which may remain trapped between the surfaces of the exchangers 82 themselves. Preferably, but not exclusively, this is a cleaning system 100 consisting of a series of nozzles fed by water having a pressure such as to ensure the detachment of the wet matrix material 8 attached to the surfaces of the cooled exchangers 82.

The drying apparatus 6 also comprises means 28 for conveying the wet matrix 8 inside the drying apparatus 6.

For example the conveying means 28 comprise a hopper 30, inside which the wet matrix 8 to be treated can be poured, and a conveyor belt 32, arranged along an inclined plane 34, which carries the wet matrix 8 along a longitudinal direction X-X.

Advantageously, the conveying means 28 comprise at least one input roller 36, arranged so as to intercept the wet matrix 8 carried by the conveyor belt 32.

The input roller 36 is arranged along a transverse direction T-T, perpendicular to the longitudinal direction X-X, and is rotating about a rotation axis R-R parallel to the transverse direction T-T.

Between the input roller 36 and the inclined plane 34 of the conveyor belt 32 a slit 40 is identified which constitutes an inlet filter at the thickness of the wet matrix 8, said thickness being at most equal to a height of said slit 40.

Therefore, said slit 40 in synergy with the outlet opening 20 is shaped so that the wet matrix 8 constitutes a cap for the introduction of air from the outside to the inside of the drying apparatus 6, so as to implement a closed system which does not introduce and does not receive air from the outside.

Preferably, the input roller 36 is shaped so as to distribute the wet matrix 8 over the entire width of the conveyor belt 32 and break up the wet matrix agglomerates 8 having a diameter or thickness greater than the slit 40.

According to an embodiment, the input roller 36 is a hollow roller which has a plurality of sieve walls 44 for the wet matrix 8, suitable for crushing the agglomerates of the wet matrix 8.

According to an embodiment, the input roller 36 comprises a plurality of bars 48, angularly arranged at a constant pitch, so as to be spaced apart from one another and identify cavities 52 between bars 48 contiguous or spaced apart.

The bars 48 act as sieve walls 44 for the wet matrix 8.

Preferably, said bars 48 are parallel to the rotation axis R-R of the input roller 36.

Preferably, said bars 48 are radially oriented with respect to the rotation axis R-R of the input roller 36.

According to an embodiment, said bars 48 are fixed to plates or supports 56 fixed to the rotation axis R-R of the input roller 36, so as not to have surfaces for adhesion to the treated wet matrix and at the same time able to better manage the quantity of material moving towards the outlet opening 20 of the drying apparatus 6.

The supports 56 therefore have the function of stiffening the structure of the input roller 36 and must have a thickness/size as small as possible so as to facilitate the passage of the wet matrix.

Preferably, the hollow input roller 36 is counter-rotating, around the rotation axis R-R, with respect to a direction of advancement of the conveyor belt 32 which carries the wet matrix 8. In this way, the effect of causing the wet material in excess to fall backwards due to gravitational effect to the correct introduction into the loading apparatus 4 is obtained.

The conveyor belt 32 is provided with blading 60 against slipping of the wet matrix 8 carried by the conveyor belt 32 itself.

The blading 60 also serves to counteract the action of gravity since the conveyor belt 32 is not flat but is inclined, with respect to a horizontal plane, by an angle of between 20° and 30°. Preferably, said angle is equal to 24°. More generally, the conveyor belt 32 is inclined, with respect to a horizontal plane, by an angle linked to the transverse width of the conveyor belt 32 according to the following formula: α=θ*L/2, wherein α is the angle of the inclined conveyor belt 32, L is the width of the conveyor belt 32 and θ is the rest angle typical of the wet material 8 to be treated. This latter derives, in a known manner, from the adhesive properties and from the static friction coefficient of the treated wet material.

According to an embodiment, the drying apparatus 6 comprises an intermediate tilting system 64 located inside the container body 10 of the drying apparatus 6, capable of intercepting and moving the entire mass of material, i.e. of wet matrix 8, in the drying step.

Preferably, said intermediate crushing system 64 is located approximately in the middle of the overall path of the conveyor belt 32 inside the container body of the drying apparatus 6, in a position suitable for the wet material 8 to create a first surface drying step to avoid the possibility that the wet material 8 itself may re-agglomerate.

In fact, the sludge of biological origin exhibits a variable behavior during the drying step. On a scientific level it has been shown that the biological material, during drying, has a transition phase called “sticky phase” which ranges from 20% to 60% by weight of dry substance. In this step, the material has a particularly sticky behavior which tends to stick both internally to the material and, externally, to the contact surfaces. Once the 60% concentration is exceeded, the internal adhesion forces and the adhesion forces to the surfaces within the sludge material are lost, leading to a tendency to crush of the agglomerates and a significant reduction in volume.

Through a series of tests on the treated materials it was possible to observe that the sludge agglomerates lapped by dehumidified air, for example with a temperature of between 50° C. and 75° C., form an extremely dry surface layer, definable as “crust”, which slows the drying of the entire mass within the agglomerate. It is therefore necessary to set up an intermediate movement system 64 specially made inside the drying apparatus 6 in a suitable position, in order to break up the agglomerates after they have created a first non-adhesive outer “crust”, crushing such agglomerates and allowing dry air to dry the interior.

If this crushing movement system were placed at the beginning of the drying process, a re-agglomeration of the sludge or wet matrix 8 would be observed, canceling the effect of the crushing system itself. Instead, thanks to a first formation of dry and no longer sticky surfaces, it is possible to avoid the formation of new agglomerates.

Preferably, the intermediate movement system 64 is located in a position, inside the drying apparatus 6, which is not lapped by a flow of air, so as to avoid the dispersion of the material moved inside the container body 10. Thus, the positioning area of the intermediate movement system 64 should preferably be free of drying air input, in order to avoid dispersion of the finer material.

The rotating bar 68 has a transverse width equal to the transverse dimensions of the conveyor belt 32.

The operation of a drying apparatus according to the present invention and the relative drying method will now be described.

In particular, the wet matrix 8 is introduced through the hopper 30, onto the conveyor belt 32, inclined by an appropriate angle with respect to the horizontal.

The conveyor belt 32 is provided with blading 60, in order to break off any formation of “bridges” or slipping between sludge and belt, along an inclined plane. Before the peak of the aforesaid conveyor belt 32, an input roller 36 is placed, which is motorized and rotates in the opposite direction to the advancement of the conveyor belt 32 itself. This input roller 36 consists of a central bar on which at least two circular plates 56 of the same diameter are hooked and fixed. On such circular plates the rotating bars 68 are fixed, preferably metal but not exclusively, perpendicular to the circular plates and preferably radial with respect to the rotation axis of the input roller 36.

Thanks to this structure, the input roller 36 is able to crush the wet matrix 8 into smaller pieces and also to distribute it in the transverse width of the conveyor belt 32.

At the same time, the input roller 36 is able to prevent a clogging of the process thanks to the fact that an internal empty space is created between the rotating bars 68 and the rotation axis of the input roller 36. The combined action between the conveyor belt 32, described above, which transports upwards the sludge material or wet matrix 8 and the counter-direction rotation of the input roller 36, causes only the sludge or wet matrix 8 of a thickness comprised between the conveyor belt 32 and the input roller 36 to be able to continue the ascent determined by the conveyor belt 32, while the material with a particle size greater than the above distance of the input roller 36/conveyor belt 32 falls backwards under the gravitational thrust.

The joint action of two opposite forces (ascending of the conveyor belt 32 and gravitational descending) creates an area immediately preceding the input roller 36 characterized by a swirling downward movement of the wet matrix. This movement leads to an opening of the sludge material towards the outside and therefore to a distribution of the wet matrix 8 over the entire transverse width of the conveyor belt 32 and consequently in the entrance into the drying chamber 12. There is therefore a precise link between the inclination of the conveyor belt 32 and its transverse width. The fall down of the material in addition to its distribution also leads to the breakdown of the larger sludge agglomerates. This break is facilitated by the structure of the input roller 36 itself, which with its rotating bars 68, preferably rectangular in shape, manages to break the surface of the agglomerates.

The input roller is deliberately left free inside to prevent any failure to the structure resulting from the presence of large solid materials, accidentally (not even so rarely in the operating environment) present and mixed with sludge. Such solid materials, in the absence of empty parts, could in fact fit between the conveyor belt 32 and the input roller 36.

Lastly, given the basically sticky nature of the wet sludge 8, the feature of the empty input roller 36 allows that there are no sludge accumulation points on the roller itself. If there was a solid cylinder with external bars, in a short time of operation a layer of sludge material would be created which would cancel the presence of the rotating bars 68. The lack of an internal surface causes the sludge material to accumulate only minimally on the rotating bars 68 but, in any case, it does not create a substantial layer of sludge, since the excess of wet matrix 8 falls to the inside of the input roller 36 and consequently (thanks to the voids between the bars) on the underlying conveyor belt.

Once the sieve made by the input roller 36 has been passed, the wet matrix, again thanks to the conveyor belts 32, proceeds inside the drying chamber 12 where it is subjected to the action of the flow of drying air. The sludge 8 before entering the drying chamber 12 encounters a further slit or outlet opening 20, of a height equal to or slightly less than the distance between the conveyor belts 32 and the input roller 36. This slit or outlet 20 allows, given its size, to slightly slow down the wet matrix 8 and therefore form a plug to the inlet and/or outlet of the external air inside the drying chamber 12.

Preferably, according to the present invention, the sludge or wet matrix 8 is dried through air recirculation at a temperature ranging from 50 to 75° C., with a dehumidification step and subsequent superheating and relative humidity reduction.

In particular, it is observed that the main drying force of evaporation does not lie in the evaporation temperature of the sludge or wet matrix 8 but in the difference in vapor pressure between the sludge or the wet matrix 8 and the relative humidity of the air.

For example, the air circulation and its dehumidification takes place through a heat exchanger 82 cooled below the dew temperature in order to condense the humidity of the air that comes from the wet matrix.

Preferably, the step of recirculating the same air inside the drying apparatus 6 is provided in order to obtain a closed system, so as not to have emissions into the atmosphere and to maintain the performance of the drying apparatus uniform.

Therefore the drying apparatus 6 is completely free of introduction and emissions of air to the outside, in order to avoid imbalances and efficiency losses in the management of humidity inside the drying chamber 12.

The at least partially dried material, inside the drying chamber 12, is further subjected to the crushing action of the intermediate crushing system 64.

In fact, as seen, the sludge of biological origin exhibits a variable behavior during the drying step: the biological material, during drying, has a transition phase called “sticky phase” which ranges from 20% to 60% by weight of dry substance. In this step, the material has a particularly sticky behavior which tends to stick both internally to the material and, externally, to the contact surfaces. Once the 60% concentration is exceeded, the internal adhesion forces and the adhesion forces to the surfaces within the sludge material are lost, leading to a tendency to crush of the agglomerates and a significant reduction in volume.

The sludge agglomerates lapped by dehumidified air, for example with a temperature of between 50° C. and 75° C., form an extremely dry surface layer, definable as “crust”, which slows the drying of the entire mass within the agglomerate. It is therefore necessary to set up an intermediate crushing system 64 specially made inside the drying apparatus 6 in a suitable position, in order to break up the agglomerates after they have created a first non-adhesive outer “crust”, crushing such agglomerates and allowing dry air to dry the interior.

As can be appreciated from the description, the present invention allows overcoming the drawbacks of the prior art.

In fact, the present invention allows a complete drying to be obtained at reduced costs.

The invention therefore provides a loading system in an oven for drying wet matrices suitably designed to not generate “bridges” of the material and at the same time to distribute the material evenly over the entire width of the conveyor belt.

Furthermore, the invention lies in the implementation of a system suitable for crushing the material being dried, in order to uniform the size of the agglomerates, placed inside the dryer in a suitable position in order not to undergo a new formation of the agglomerates themselves.

The device has condensation and overheating systems of the air circulating in the drying oven to encourage the removal of moisture from the wet material, combining the reduction of relative air humidity and the mechanical action of the air itself. The device is also composed of a system managed by one or more heat pumps or fluids capable of generating cold surfaces for condensing moisture and overheated surfaces due to the increase in air temperature and its consequent lowering of the relative humidity.

The use of heat pumps is optimized thanks to the treatment of the wet matrices both at the entrance and inside the drying apparatus: in this way the energy performances of drying are maximized to encourage the removal of the humidity of the wet material, combining the lowering of the relative humidity of the air and the mechanical action of the air itself.

A man skilled in the art may make several changes and adjustments to the drying apparatus and to the drying methods described above in order to meet specific and incidental needs, all falling within the scope of protection defined in the following claims.

What is claimed is:

1. A drying apparatus of a wet matrix comprising:
air insufflation and suction means, suitable for generating a drying flow directed towards the wet matrix in at least one drying chamber to facilitate removal of water from said wet matrix,
means for conveying the wet matrix inside the drying apparatus, comprising a conveyor belt that transports the wet matrix along a longitudinal direction (X-X),
wherein
the drying apparatus comprises at least one heat exchanger cooled below dew temperature to condense humidity of air coming from the wet matrix.

2. The drying apparatus of claim 1, wherein the drying flow is recirculated through two heat exchangers; a cooled heat exchanger and a superheated heat exchanger, to first dehumidify and then superheat and dry recirculated air.

3. The drying apparatus of claim 2, wherein the two heat exchangers are integrated in a same heat pump to condense humidity of air deriving from the wet matrix being dried, through the cooled heat exchanger, and then overheat the same air with the superheated heat exchanger.

4. The drying apparatus of claim 2, wherein said two heat exchangers are connected in series with each other by at least one fan that creates a flow of air flowing in series between said two heat exchangers.

5. The drying apparatus of claim 3, wherein the drying apparatus further comprises a closed air circuit through the heat pump and said two heat exchangers.

6. The drying apparatus of claim 5, wherein the closed air circuit is made to ensure airtightness of the closed air circuit and continuous recycling only of air inside the closed air circuit and inside the at least one drying chamber.

7. The drying apparatus of claim 2, wherein the superheated heat exchanger comprises a double circuit in series, comprising a coolant delivery circuit and a coolant return circuit.

8. The drying apparatus of claim 7, wherein between said coolant delivery and return circuits is interposed a cooling heat exchanger suitable for lowering excess heat deriving from the drying apparatus and preventing thermal shock inside the superheated heat exchanger.

9. The drying apparatus of claim 8, wherein said cooling heat exchanger has two flows, a flow of coolant liquid and a flow of cold liquids or air.

10. The drying apparatus of claim 2, wherein the flow of air conveyed to the at least one drying chamber is split into two separate circuits, while the coolant circuit is unique and is split in parallel on two cooled exchangers and on two superheated exchangers.

11. The drying apparatus of claim 10, wherein the two cooled exchangers are provided with a cleaning system suitable for eliminating solid residue of wet matrix carried by air.

12. The drying apparatus of claim 11, wherein said cleaning system comprises a plurality of nozzles fed by water having a pressure such as to guarantee detachment of the wet matrix attached to surfaces of the two cooled exchangers.

13. The drying apparatus of claim 1, wherein said means for conveying the wet matrix comprise at least one input roller, arranged to intercept the wet matrix carried by the conveyor belt, the at least one input roller being arranged along a transverse direction (T-T), perpendicular to the longitudinal direction (X-X), wherein a slit is identified between the at least one input roller and the conveyor belt that constitutes an inlet filter at a thickness of the wet matrix, said thickness being at most equal to a height of said slit.

14. The drying apparatus of claim 13, wherein said slit is shaped so that the wet matrix constitutes an obstruction to an input of air from outside into the drying apparatus.

15. The drying apparatus of claim 1, wherein the conveyor belt is inclined, with respect to a horizontal plane, by an angle of between 20° and 30°.

16. The drying apparatus of claim 1, wherein the conveyor belt is inclined, with respect to a horizontal plane, by an angle linked to a transverse width of the conveyor belt and to physical properties of the wet matrix according to the following formula: α=θ*L/2, wherein α is equal to the inclination angle of the inclined conveyor belt, L is equal to the width of the conveyor belt and θ is equal to a rest angle typical of the wet matrix to be treated.

17. A method of drying a wet matrix, the method comprising conveying at least one wet matrix inside a drying apparatus comprising:
air insufflation and suction means, suitable for generating a drying flow directed towards the wet matrix in at least one drying chamber to facilitate removal of water from said wet matrix,
means for conveying the wet matrix inside the drying apparatus, comprising a conveyor belt that transports the wet matrix along a longitudinal direction,
wherein
the drying apparatus comprises at least one heat exchanger cooled below dew temperature to condense humidity of air coming from the wet matrix.

18. The method claim 17, wherein a main drying force does not lie in temperature of input air, but in a vapor pressure difference between the wet matrix and relative humidity of air.

19. The method of claim 17, wherein air circulation and its dehumidification take place through the at least one heat exchanger cooled below dew temperature to condense humidity of air coming from the wet matrix.

20. The method of claim 17, wherein a step of introducing air into the drying apparatus with a temperature ranging from 50-° C. to 75-° C. is provided, in order to reduce as much as possible the relative humidity of the drying flow and thermally facilitate drying of the wet matrix.

21. The method of claim 17, wherein a step of recirculating the same air inside the drying apparatus is provided in order to obtain a closed air circuit, so as not to have emissions into atmosphere and to maintain performance of the drying apparatus uniform.
